(19) United States
(12) Patent Application Publication
(10) Pub. No.: US 2003/0229507 A1
(43) Pub. Date: Dec. 11, 2003

(54) System and method for matching donors and charities

(76) Inventor: Damir Perge, Saratoga, CA (US)

Correspondence Address: William J. Kolegraff, 3119 Turnberry Way, Jamul, CA, 91935, US

(21) Appl. No.: 10/357,544

(22) Filed: Feb. 3, 2003

Related U.S. Application Data
(63) Continuation-in-part of application No. 09/904,645, filed on Jul. 13, 2001.

(51) Int. Cl. G06F 17/60

(52) U.S. Cl. 705/1

(57) ABSTRACT

The charitable matching system incorporates a method enabling a donor or a charity to prepare a profile template. The profile template provides information parameters useful in matching a donor with a charity, or in matching a charity with a donor. A level of privacy may be identified for each information parameter in the profile, which is useful in limiting the dissemination of information. In identifying potential matches, the matching system uses all available information parameters, irrespective of any privacy limitation. When a match is confirmed by the matching system, notifications are restricted from transmitting information parameters having a privacy level indicating the donor or charity did not desire to disseminate that information.

### RELATED APPLICATION

The present application is a continuation-in-part of U.S. patent application Ser. No. 09/904,645, filed Jul. 13, 2001, and entitled “System and Method for Matching Business Partners”, which is incorporated herein in its entirety.

### FIELD

The field of the present invention is electronic data processing systems. More particularly, the present invention relates to an electronic processing system for matching a donor with a charitable entity.

### BACKGROUND

In charitable giving, it is often difficult to pair a qualified donor with the right aid organization or charity. For example, a donor may want to donate a specific gift, such as a sum or money or an asset, or provide a particular service for a reduced cost. Further, the donor may be giving their gift or service for a very personal or emotional reason. The donor may want to carefully choose between several, or even hundreds, of donation opportunities before selecting the right donation vehicle. In this process the donor wants to evaluate each charity as fully as possible, so therefore must seek specific information about each charity.

Fully evaluating a charity, especially for a large gift, requires detailed and accurate information, which is often not available to the public at large. Accordingly, the donor may rely on the public information in deciding whether to donate. In this regard, the donor may not consider some possible charities because of a lack of detailed information, or may end up donating to a less than preferred organization because of incomplete information on that organization.

Alternatively, the donor may reveal their identity to a select few charities to obtain more detailed information before making a final selection. Such requests may lead to the charities competing for the donor's gift. Unfortunately, making a donation in such a competitive environment may be unpleasant for the donor, and there is substantial risk that their donation intention may become widely known. Once their donation intention is known, then other charities, irrespective of the donor's charitable intensions, may inundate the potential donor with donation requests. For this and other reasons, many donors wish to remain anonymous in their donations.

In making donations, a donor often relies on the advice of others, such as friends, other donors, and even charitable newsletters or magazines. Such information is quite valuable, especially the information from trusted advisors or friends. Unfortunately, it is unlikely that even close friends will have identical donation interests, and so getting advice from friends and advisors may be biased in an attempt to convince the prospective donor to donate to the friend's charity. Further, if the donor does not make a donation to the friend's charity, then the friendship may be hurt. Accordingly, even though advisors and friends may be a good source of donation information, receiving and using such information must be carefully considered by the donor.

Charities, too, have difficulty attracting appropriate donors. For example, some charities may be able to offer particular benefits, such as complementary box seats or private showings, for donors making specific gifts. The charity may not want the offer of such benefits to be widely known, as it may negatively affect other fund raising activities. Further, the charity may need a particular service or skill, and may not want the general public to know of that specific need. Also, since major donors to a charity may be anonymous, especially famous donors, the charity is generally not able to take advantage of the goodwill associated with receiving a donation from a famous person.

The current process of matching donors and charities is ad hoc, and generally based on incomplete and insufficient information. In this regard, the donor may not provide their gift to the most desirable charity, and the charity most needing of a particular gift may not be able to find the capable donor. Therefore, there exists a need for a more rigorous process for matching donors and charities.

### SUMMARY

It is therefore an object of the present invention to provide an automated system for assisting in matching donors and charitable entities. It is another object of the present invention to enable efficient sharing of information between a donor and a prospective charitable entity, but to maintain a desirable level of anonymity during the matching and donation process.

To overcome the deficiencies in the prior art, and meet the stated objectives, an automated charitable matching system is disclosed. Briefly, the charity matching system enables a donor or a charity to prepare a profile template. The profile template provides information parameters useful in matching a donor with a charity, or in matching a charity to a donor. Parameters, such as type of gift, level of required anonymity, and limitations on use of gift, enable the matching system to make an initial matching decision. The donor or charity may also indicate a level of privacy for each information parameter in the profile, which is useful in limiting the dissemination of information. In identifying potential matches, the matching system uses all available information parameters, irrespective of any privacy limitation. When the matching system identifies a potential match, the parties are notified, but the notifications are restricted from transmitting any private information. Accordingly, the matching system emulates an intermediary by using all information to identify a match, but maintaining the confidentiality of private information.

In a particular embodiment of the matching system, the matching system maintains a historical database of past successful donations, and also maintains a file of current donors and current charities. Accordingly, the charitable matching system is able to predict which current donors and charities are likely to be successfully matched based on the characteristics and parameters of past successful relationships. More specifically, the matching system selects a target donor, and using historical data, identifies a set of charities that are potential matches for that donor. Preferably, the target donor has indicated a desired charitable goal, such as naming rights to a building. The matching system finds a set of past donors in the historical database that are generally similar to the target donor, and further reduces the set by selecting only those past donors that successfully achieved the same desired outcome. Since each successful past donor had a corresponding past charity, the matching system efficiently generates a set of past charities that successfully achieved the desired outcome with donors similar to the target donor.

If any of the past charities in the set are also current charities, they may be notified, without disclosing the donor's private information, that a match potential has been identified. However, the matching system may also be configured to expand the number of potential matches. For example, the matching system may use the characteristics of the set of past charities to find a set of current charities having similar parameters. By incorporating past success in the selection process, the example searching method is likely to return high quality potential matches.

In another embodiment of the present invention, the matching system provides for a real-time match between donors and charities. In one such example, a charity makes a real-time query into a current database of donors, with each donor having an information profile that includes at least one private data parameter. More specifically, the charity makes a query of information parameters, some of which may be marked as private by the donor. To facilitate an efficient, yet anonymous exchange of information, the matching system allows a donor to set a minimum number of the queried parameters that must be private, thereby increasing the anonymity of the transaction. However, to satisfy the charity that donors found by the query are acceptable, the charity is able to set a maximum number of private parameters that are allowed not to match. In this regard, the charity increases the reliability of the search.

In a converse of the above embodiment of the present invention, the matching system enables a donor to make a real-time query into a current database of charities, with each charity having an information profile that includes at least one private data parameter. More specifically, the donor makes a query of information parameters, some of which may be marked as private by the charity. To facilitate an efficient, yet anonymous exchange of information, the matching system allows a charity to set a minimum number of the queried parameters that must be private, thereby increasing the anonymity of the transaction. However, to satisfy the donor that charities found by the query are acceptable, the donor is able to set a maximum number of private parameters that are allowed not to match. In this regard, the donor increases the reliability of the search.

Advantageously, the matching system enables efficient and effective matching of donors and charities using an automated system. Since the matching system makes matching recommendations based on a broad base of information, the matching system is likely to provide a high quality pairing. Importantly, even though the matching system is making matching decision on the broad base of information, the matching system only provides others' information previously approved for dissemination. Accordingly, the matching system acts as an intermediary by facilitating efficient matching while maintaining desirable anonymity. Further, the present matching system enables a prospective donor to anonymously use information from others, such as experts or other types of advisors.

### BRIEF DESCRIPTION OF THE DRAWINGS

FIG. 1 is a block diagram of a matching system in accordance with the present invention;

FIG. 2 is a sample input form for a matching system in accordance with the present invention;

FIG. 3 is a flowchart of a historical matching system in accordance with the present invention;

FIG. 4 is a flowchart of another historical matching system in accordance with the present invention; and

FIG. 5 is a flowchart of a real-time matching system in accordance with the present invention.

### DETAILED DESCRIPTION

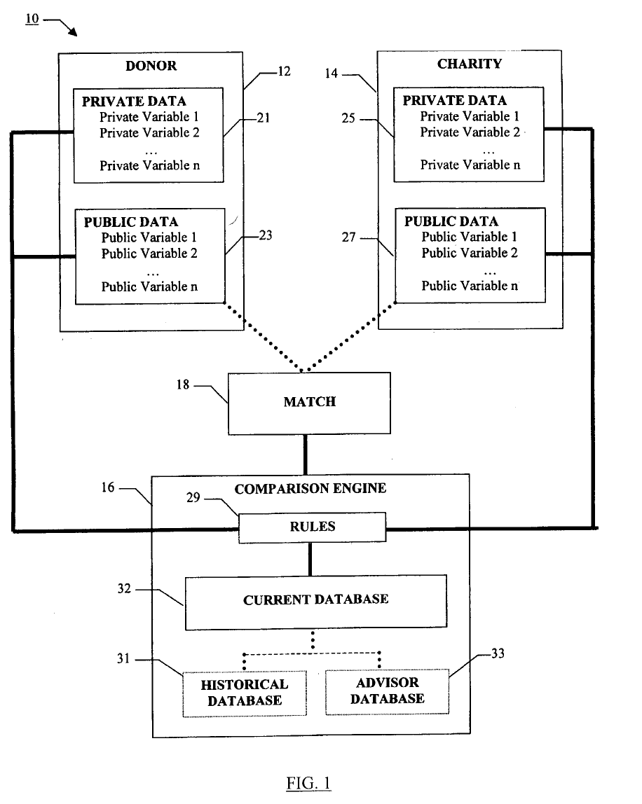

Referring now to FIG. 1, a charitable matching system 10 in accordance with the present intention is shown. Charitable matching system 10 is a computerized system that matches prospective donors with charities or other donation opportunities, such as schools. The system may operate in an on-line mode for immediate access by donors or charities, or may be operated by a service entity that notifies donors and charities of potential matches. In a specific application, the matching system 10 acts as an automated system to identify potential matches between donors and charities, and facilitates their further detailed communications without compromising sensitive data. Further, matching system 10 allows donors to carefully consider many charitable opportunities, and select the charity that is most appropriate for their gift and their desires.

Matching system 10 uses a sophisticated comparison engine 16 to facilitate matches to connect donors and charities so that they can share goals, learn more about each other, form a giving plan, and finalize a donation. By efficiently facilitating such pairings, the matching system 10 creates an environment in which these entities can achieve better matches than with traditional off-line or known online networking communities, leading to a more satisfied donor, and optimizing the use of the donor's gift.

Preferably, matching system 10 is arranged as an Internet enabled application. Accordingly, remote parties may conveniently use matching system 10. It will be appreciated that certain aspects of the matching system 10 may be resident on a server, while other aspects are located on a remote client. It will be further appreciated that the relationship between the client and server may be adjusted for application specific needs. For example, some implementations could benefit from increased local processing of data, while other implementations may be more reliant on the server's processing power. Other implementations of the matching circuit 10 are also contemplated, such as bulletin board systems or other such online systems. Further, matching system 10 may be done in off-line mode by a service provider.

A key feature of matching system 10 is the capability to effectively use all available information while maintaining desirable anonymity. By maintaining the privacy of confidential information, parties are encouraged and enabled to make full and honest disclosures, thereby facilitating effective and efficient matching. Generally, the matching system 10 identifies potential matches by using the full amount of information available for donors and charities. However, when a potential match is identified, the matching system 10 does not disseminate information that any party identifies as private. Accordingly, the matching system 10 acts as a sophisticated intermediary that is able to make intelligent matching choices, but still maintain desirable confidentiality. Further, even though confidentiality may be maintained, each party has a high degree of confidence in the results produced by the matching system 10. In a preferred example, matching system 10 uses information compiled from experts, peers, or other advisors, in an anonymous manner, to increase the confidence in a particular match.

In one example of the matching circuit 10, the donor enters data into the system using a donor profile template 12, while the charity enters data into system using a charity profile template 14. It will be appreciated that a donor may be an individual, but also-may be another entity such as a trust or business. Further, it is contemplated that that the matching system will be useful irrespective of the size of the gift contemplated. For example, the donor may be an individual seeking to donate a set of books, or the donor may be a well-endowed trust seeking naming rights to a new building.

The charity completes a charity profile template 12. The donor profile template 12 includes private donor data 21 and public donor data 23. Generally, the donor supplies the donor profile template 12 with enough information to enable the matching system to effectively locate a likely charity match. As privacy of the information is assured, the donor is enabled to make a full and honest disclosure of information. In entering the data, the donor enters specific information into variables.

A preferred profile template comprises several variables. For example, a typical template may include 20 or more variables. The donor selects which of these variables are appropriate to answer, and supplies the necessary information to complete the variable. Each variable may then be assigned a particular privacy level. In a preferred embodiment, each variable may be assigned either a “private” privacy level or a “public” privacy level. For example, selected variables in donor profile template 12 have been designated as private. Accordingly, this data is identified as private donor data 21. Other data variables in the donor profile template 12 have been designated as public. The public data variables are shown as public donor data 23. It will be appreciated that the matching system 10 may incorporate more than 2 levels of privacy to facilitate a more sophisticated control of information flow.

The donor completes the donor profile template 12 by entering specific information into variables. For consistency, the variables are typically predefined to facilitate effective matching. For example, one predefined variable may ask that a donor indicted if they prefer to do a one-time gift, or if they plan to give over time. When completing this variable, the donor may be asked to make a selection from a predefined list. The list could include several choices, such as a one-time gift, annual gift, or a gifts as needed. Preferably, the list is configured as a selection box for an online system. It will be appreciated that other input methods may be used, such as check boxes or radio buttons.

It will be appreciated that the donor profile may include many data fields intended to better understand the donor's ability to give and the donor's personal motivation in giving. For example, the donor profile may inquire about specific skills or possessions the donor may consider gifting. The donor profile may also interrogate the types of charities that the donor prefers, such as for a particular disease or a school focusing on a particular technology. Also, the donor profile may ask if the donor desires anything in return for the gift, for example, such as naming rights to a new building, or preferred event seating. It will be appreciated that the donor profile may be used to collect sufficient information to effectively understand the donor's giving desires and ability.

In a similar manner, the charity completes a charity profile template 14. It will be appreciated that a charity may be an aid organization such as the Red Cross or Cancer Society, but also may be another entity such as a school or library. Further, it is contemplated that that the matching system will be useful irrespective of the size of the gift desired. For example, the charity may be a library that is seeking donation of specific types of works, or the charity may be a hospital that is seeking a substantial donation to build a new wing. The charity profile template 14 includes private charity data 25 and public charity data 27.

Generally, the charity supplies the charity profile template 14 with enough information to enable the matching system to effectively locate a likely donor match. As privacy of the information is assured, the charity is enabled to make a full and honest disclosure of information. In entering the data, the charity enters specific information into variables.

For example, a typical charity template may include 20 or more variables. The charity selects which of these variables are appropriate to answer, and supplies the necessary information to complete the variable. Each variable may then be assigned a particular privacy level. In a preferred embodiment, each variable may be assigned either a “private” privacy level or a “public” privacy level. For example, selected variables in charity profile template 14 have been designated as private. Accordingly, this data is identified as private charity data 25. Other data variables in the charity profile template 14 have been designated as public. The public data variables are shown as public charity data 27.

The charity completes the charity profile template 14 by entering specific information into variables. For consistency, the variables are typically predefined to facilitate effective matching. For example, one predefined variable may ask that a donor indicted the percentage of donations used for fund raising costs. When completing this variable, the donor may be asked to make a selection from a predefined list. The list could include several choices, such as a less than 5%, 5% to 12%, or over 12%. Preferably, the list is configured as a selection box for an online system. It will be appreciated that other input methods may be used, such as check boxes or radio buttons.

It will be appreciated that the charity profile may include many data fields intended to better understand the charity's need, expected use of the gift, and potential incentives for donating, such as naming rights. For example, the charity profile may inquire about specific skills or assets the charity needs. The charity profile may also interrogate the types of donors that the charity prefers, such as individual, corporate, annual, bequeath, or property. Also, the charity profile may ask if the charity can provide anything in return for the gift, for example, such as naming rights to a new building, or preferred event seating. It will be appreciated that the charity profile may be used to collect sufficient information to effectively understand the charity's giving desires and ability.

The matching system 10 has a comparison engine 16 for identifying potential matches. More specifically, the comparison engine 16 maintains a current database 32 of active current donors and active current charities. Each of the current participants has previously completed a profile template, such as donor profile template 12. The comparison engine 16 also includes a set of sophisticated rules 29. Typically, the rules 29 will be implemented as software algorithms. Depending on the particular matching situation, the comparison engine 16 may apply different rules 29. Specific rules will be more fully addressed below.

In one particular example of matching system 10, the comparison engine 16 also includes an optional historical database 31. The historical database 31 includes records of past successful matches. A match is considered successful when a donor and a charity reached a mutually desired outcome. In a particular example, the match can be considered successful when the donor's desired outcome was attained. Further, the historical database may additionally track previous pairings that did not result in a successful match.

In another particular example of matching system 10, the comparison engine 16 also includes an optional advisor database 33. The advisor database may include, for example, an evaluation by an auditing firm on the financial figures presented by the charity. The donor, thereby, could set parameters that required a certain level of confidence by an advisor, or that excluded charities that had particularly low ratings by an advisor. Accordingly, the donor may selectably take advantage of expert and advisor opinion, while yet remaining anonymous. Although the advisors and experts may also desire to remain anonymous, the system also contemplates express statements by known experts. In this regard, a known and respected expert could provide evaluations in the advisor database, and a donor could require that a particular advisor to have made a positive evaluation of a charity for that charity to be further considered.

The rules 29 of comparison engine 16 use all available information on donors and charities to identify potential matches. For example, rules 29 use both the private data 21 and public data 23 in donor profile 12 when attempting to identify a potential match for that donor. In a similar manner, rules 29 use all available data from a charity, such as private data 25 and public data 27 in charity profile template 14. Additionally the rules 29 have access to full private and public data in the current database 32 and the historical database 31, if present.

Once the comparison engine 16 identifies potential match, the match is identified by match presentation 18. In a preferred embodiment, match presentation 18 is accomplished via an e-mail notification. More specifically, a donor may be notified that a particular charity is a potential match, and the charity may likewise be notified that the donor appears to be a match. The system may be configured so that only one party, such as the donor, receives the notification.

In the notifications, the matching system 10 does not disclose any private data, such as private donor data 21 or private charity data 25. Instead, matching system 10 only discloses information identified as being public. It will be appreciated that more sophisticated control of information may be accomplished by incorporating more than 2 levels of privacy. It will also be appreciated that other methods of notification may be used.

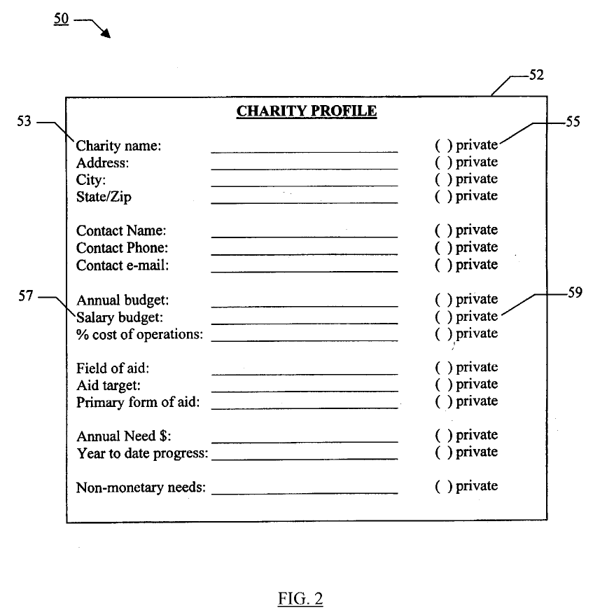

Referring now to FIG. 2, an example charity profile template input form 50 is shown. In a preferred embodiment, form 52 provides similar and complementary questions and fields for both the donor and the charity. Such similarity facilitates efficient matching. In use, the charity uses information variables on form 52 to present information regarding themselves, while the donor would use similar variables on a similar form to describe qualities and features they are searching for. Although form 52 indicates several free-form fields, it is understood that more structured data may also be input, such as drop boxes and selection items. It will also be appreciated that more sophisticated rules engines would benefit from the use and analysis of free-form fields.

The input form 52 includes several variables, such as charity name 53 and salary budget 57. On form 52, each variable has a label and an area for inserting information. It will be appreciated that any number of variables may be used, however, enough variables should be presented and collected to enable efficient and accurate matching. Generally, the more variables presented and completed, the better the matching accuracy and efficiency.

Form 50 invites a person completing the form to provide specific information regarding the entity they represent. Some of the input variables, such as charity name 53, may require a free form input format. Other input variables, such as salary budget 57, lend themselves to selectable items. For example, the input area for salary budget 57 may include a pull down box where the person completing the form selects one of several revenue ranges. It will be appreciated that other selectable input methods may be used. Alternatively, data variables such as salary budget 57 may also be arranged as free form input, but then the rules used by the comparison engine must be constructed to interpret such free form input.

Form 52 also permits the person completing the form to indicate a privacy level for each data variable. For example, the person completing the form may indicate that the charity name 53 shall remain private by selecting private box 55. In a similar manner, salary budget 57 could be made private by selecting private box 59. In a particular illustration, the person filling out form 52 may identify salary budget 57 as private. Even though identified as private, the rules of the comparison engine will still use salary budget 57 in locating potential matches. However, once a potential match is identified, the potential match will receive a notification that does not disclose salary budget 57. Accordingly, the matching system fully utilizes all information it receives in making efficient matches, but protects from dissemination any information that the discloser regards as private.

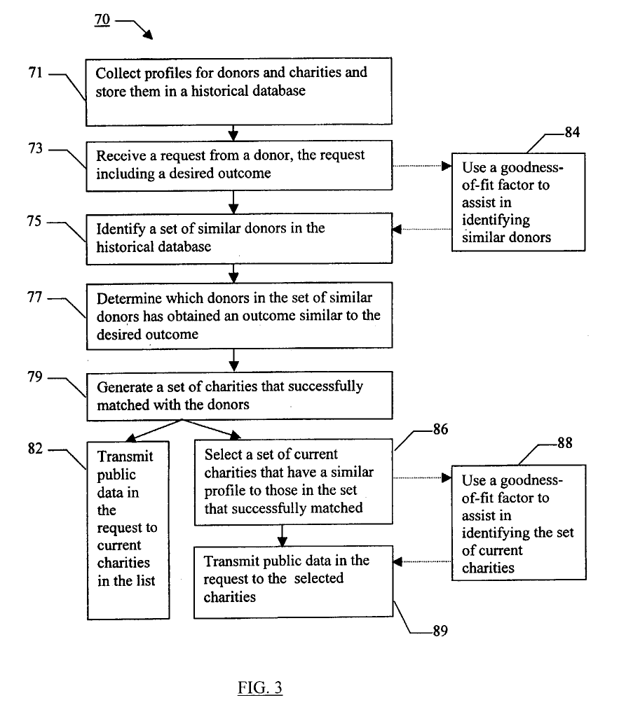

Referring now to FIG. 3, a specific method of matching 70 is disclosed. In particular, matching method 70 uses a historical database that includes successful matching pairs to more effectively identify potential matches. It will be appreciated that the historical database may contain other information, such as information regarding unsuccessful previous pairings. Additionally, it will be appreciated that the historical database may contain information received from other public or private sources. In this regard, a newly activated matching system may still incorporate a degree of historical database. Of course, as time progresses, the information contained in the historical database will increase and the system is likely to yield more effective potential matches.

Block 71 shows that matching method 70 collects and stores profile template information for past donors and past charities in the historical database. As described above, such profile information may include information derived from other private or public sources, such as newsletters, magazines, or experts and advisors in the field. The information stored regarding the donors and the charities will include an indication of whether particular matched pairs were able to reach a desired outcome, such as a gifting event. It will be appreciated that other desired outcomes could be tracked, such as the successful use of a donor skill or service in the charity's affairs. Although system 70 contemplates using historical success data, it will be appreciated that information indicating an unsuccessful match may also be useful.

In block 73, a current donor completes a donor profile template, which includes an indication of the outcome desired by that donor, such as the successful donation of a specific sum of money. It will be appreciated that the profile template may include any number of data variables, and the data variables may be assigned a privacy level with at least some of the data variables identified to be private.

In block 73, the profile template of the current donor is used to identify a set of similar past donors. More specifically, the method 70 compares the data variables, including private variables, in the current donor's profile template to the profile templates of past donors. The method selects a set of those past donors having similar data parameters. It will be appreciated that block 75 could be implemented in alternative ways. For example, block 75 could require exact matches between all data variables before selecting a past donor. Alternatively, a goodness of fit factor could be used, as shown in block 84, to expand the number of past donors selected as being similar. For example, block 84 could require that the current donor and a past donor have a minimum number of matching data parameters before the past donor is selected. In such a manner, a past donor would be identified as similar even though all data parameters may not match exactly. It will be appreciated that other methods may be used to expand the set of similar past donors returned by the system in block 75.

With the set of similar past donors defined, block 77 uses the historical database to determine which of the donors in the set obtained the same outcome desired by the current donor. For example, if the current donor is attempting to donate real estate, then block 77 would select only those past donors that successfully donated real estate to their respective charity. The past donors that did not obtain the desired result are excluded from the set. It will be appreciated that the determination of successful past donors in blocks 75 and 77 may be accomplished using a different sequence. For example, the method could first select past donors that reached the desired outcome, and then select only those past donors that are similar to the current donor. It will be appreciated that other procedures may be used to select a set of similar successful past donors. It will also be appreciated that a similar process may be used with regard to current and past charities.

The historical database contains information regarding successful matches, including the identities of the donor and the charity. Accordingly, in block 79 the method 70 is able to generate a set of past charities that correspond to the set of past donors generated in block 77. This set of past charities contains those past charities that successfully reached the desired outcome with donors similar to the current donor.

It is possible that one or more of the selected past charities are still active current charities in the system. If so, in block 82 active charities may be extracted from the set of past charities and these charities notified about the current donor. In accordance with the method 70, none of the private information of the current donor is disclosed to the charities.

With an online system, it is likely that current charities will continually be added or deleted from the system. Accordingly, the set of charities generated in block 79 will likely contain past charities that are no longer active in the system, and will not indicate other newer charities that may be interested in knowing about the current donor. Therefore, in block 86 the method uses the set of past charities generated in block 79 to generate a set of current similar charities.

More particularly, charities in the set of current charities are selected to have a similar profile as to those charities in the set of past charities. As with the procedure described above, similar charities are selected based on matches of data variables, including private variables, in their profile template. A goodness of fit factor, as shown in block 88, may be used to expand the set of similar charities. For example, the goodness of fit factor may be set to select charities where only a set number of factors match.

In block 89, public information regarding the current donor is transmitted to the charities in the set of similar charities. As above, the charities do not receive any information the donor indicated as private, although the private information was used in the matching process.

In a particular example of method 70, the goodness of fit factor of block 84 and the goodness of fit factor of block 88 may be adjustable. In this regard a user of method 70 may adjust the factors in order to obtain the desired quantity and quality of results. For example, a particular search may be more successful by stringently selecting the set of similar donors while more loosely selecting the set of current charities. It will be appreciated that the goodness of fit factors may be made adjustable in alternative ways, such as by allowing a donor to adjust slider bars or selecting a minimum number of factors that must match exactly.

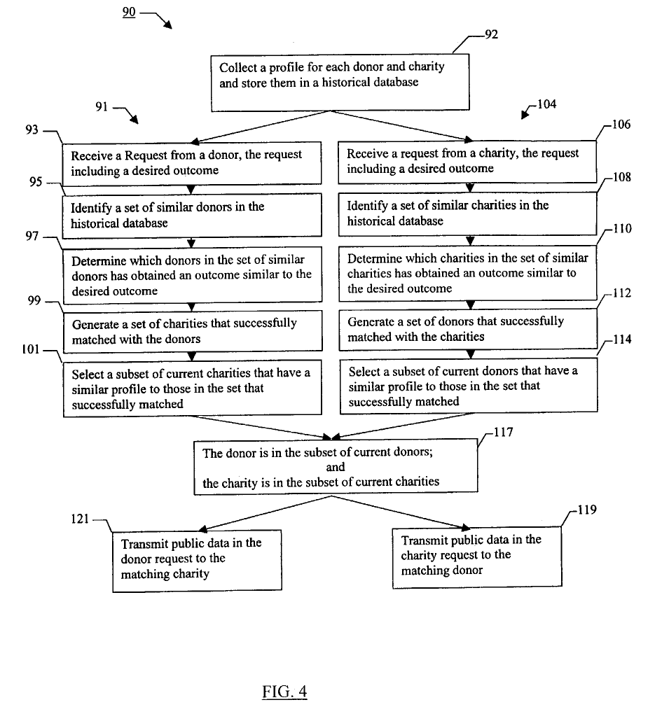

Referring now to FIG. 4 another method of matching 90 is disclosed. Matching method 90 provides a process that generates a limited number of high-quality potential matches. Accordingly, matches generated by method 90 may have a high probability of generating a desired outcome. Portions of method 90 are similar to method 70, previously described, so will not be detailed. For example, in block 92 profiles are stored in a historical database similar to the manner already described. Further, blocks 93, 95, 97, 99, and 101 define a set selection process 91 that generates a set of current charities similar to the process already defined in method 70. In particular, set selection process 91 operates on a profile template from a current prospective donor. However, method 90 uses the generated set of current charities differently than method 70.

Method 90 generally applies the set selection process 91 to other current profile templates. For example, set selection process 104 is similar to set selection process 91, except that set selection process 104 is applied to a current charity profile. More particularly, blocks 106, 108, 110, 112, and 114 of set selection process 104, are similar to blocks 93, 95, 97, 99, and 101 of set selection process 91, respectively. Although method 90 shows the set selection process 91 and 104 operating on only two profile templates, it is contemplated that method 90 may perform a similar set selection process on several profile templates. For example, method 90 may even perform a set selection process for every current profile template. It will be appreciated that method 90 may be automatically performed or may be done in response to an instruction, such as a user command.

The set selection process, such as set selection process 91 or 104, generates a potential match list for each profile template. More specifically, the potential match list from process 91 identifies potential current charities for the donor, while the potential match list from process 104 identifies potential current donors for the charity. If the charity appears in the donor's match list, and the donor appears in the charity's match list, then the method has a high degree of confidence that the donor and the charity are a good match. Therefore, block 117 attempts to locate the donor in the subset of current donors generated in block 114, and also attempts to locate the charity in the subset of current charities generated in block 101. If both conditions are met, then method 90 proceeds to notify the donor in block 121 and the charity in block 119 that a potential match has been identified. In accordance with method 90, no private information is disseminated, although the private information was used in making the match.

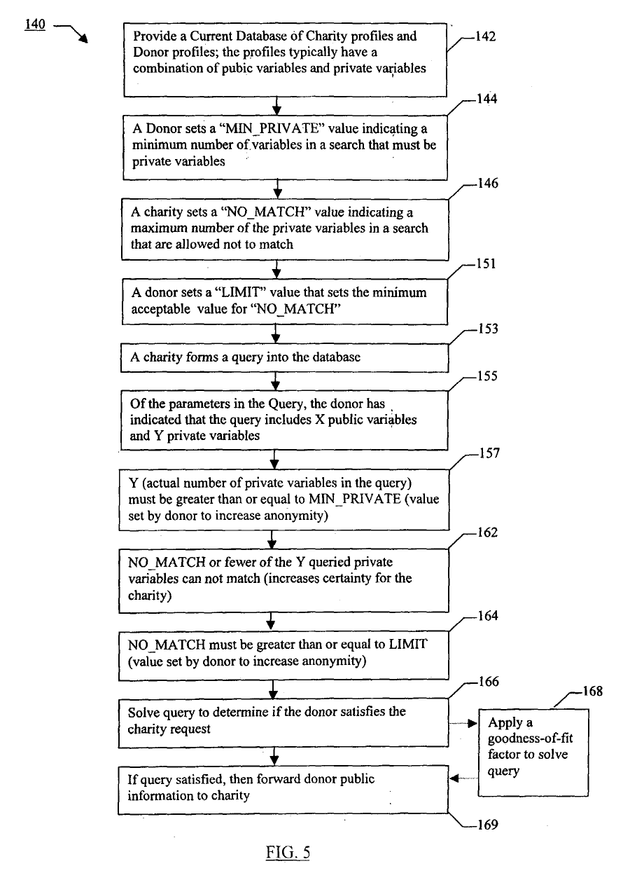

Referring now to FIG. 5, another method of matching 140 is disclosed. Matching method 140 is preferably a real-time matching system. In this regard, a charity generates a query into a database of current donors, with method 140 returning a list of potential matching donors. Similarly, a donor may generate a query into a database of current charities, with the method returning a list of potential matching charities. Although FIG. 5 illustrates a real-time query by a charity, it will be appreciated that the method to perform a real-time query by a donor is also contemplated by the method 140.

Although not required, the real-time system may also benefit from a historical database. Such a historical database could provide the search engine with additional information to form more efficient and effective matching lists. However, for purposes of describing method 140, the historical database will not be described.

Although also not required, the real-time system may also benefit from an advisor database as described above. Such an advisor database could provide the search engine with additional information to form more efficient and effective matching lists. However, for purposes of describing method 140, the advisor database will not be described.

A real-time matching method, such as method 140, generally operates by having a charity make a query into a database. More specifically, the charity selects particular variables to query, and selects a value or a range of values acceptable for each variable. Matches are identified when there is a high degree of similarity between the variables in the query and the respective variables in a donor profile template. Depending upon the specific application, differing degrees of similarity may be required. For example, a query may be made that requires only a minimum number of variables to match. In this regard, even if several variables do not match, the profile template may be identified as a potential match. In a particular embodiment of method 140, a goodness of fit variable may be set for adjusting the requisite similarity to identify a match.

In a real-time matching system, such as matching system 140, the needs of a charity may be in tension with the needs of a donor. For example, the donor probably desires to retain/a high level of anonymity, which suggests that the search be accomplished with at least some degree of uncertainty. In contrast, the charity probably desires that the match have as high a degree of certainty of gifting as possible. Accordingly, method 140 provides a process that strikes a balance between the uncertainty desired by the donor and the certainty desired by the charity.

In block 142, a current database of profile templates is provided. The database typically includes information profiles stored by other charities and donors, and includes a combination of public and private variables. It will be appreciated that although method 140 uses two levels of privacy, additional levels may be used to more finely controlled dissemination of data parameters.

As shown in block 144, the donor is able to influence the level of uncertainty for a search. More specifically, each donor sets a variable, identified as “MIN_PRIVATE”, that is stored with their profile template. This value sets the minimum number of variables in a particular query that the donor must have identified as private. For example, assume that a particular donor has set MIN_PRIVATE to a value of 2. Further, assume that a charity prepares a query into the database using 5 variables, and that the particular donor has identified only 1 of the 5 queried variables as private. In this example, even if all 5 variables match, method 140 will not identify this donor as a potential match. In this regard, the donor has made a decision that they want to retain anonymity by increasing the level of uncertainty of the search. Of course, the donor may be able to increase the number of matches by reducing the value the set for MIN_PRIVATE. For example, in the example described above, setting MIN_PRIVATE to a value of 1 may have allowed the donor to be matched with the charity.

However, as described earlier, a charity has an interest in increasing the level of certainty in a search. Accordingly, in block 146, the charity is able to set the value for a variable identified as “NO_MATCH”. With this variable, the charity sets the maximum number of private variables in a search that are allowed not to match. Thereby, even if a substantial number of the variables queried by the charity are held private by the donor, the charity has control over the maximum number of private variables that do not match. By reducing the value of NO_MATCH, the charity is able to increase the certainty of the search. Of course, if the charity reduces NO_MATCH too low, then the charity may exclude desirable potential matches.

In block 151 the donor also sets a “LIMIT” variable. The value of LIMIT permits the donor to set a minimum value for the NO_MATCH value, which is set by the charity. In this manner the donor can again influence the level of uncertainty in the search. More specifically, the value of NO_MATCH must be greater than or equal to LIMIT for the donor's profile to be considered by the matching method. For example, the donor may set the value of LIMIT high enough so that the charity cannot confidently predict which variables did not match.

The method 140 contemplates that MIN_PRIVATE and LIMIT are set and adjustable by the donor, and the NO_MATCH is set and adjustable by the charity. It will be appreciated that not all these variables need to be present on each implementation of a real-time matching system, and that additional such limiting variables may be added. Further, it is understood that one or more of these variables may be set by the matching method, either statically or in response to a rule.

A charity forms a query into the database in block 153. In making the query, the charity does not know which of the queried variables any particular donor has made private. As described earlier, the matching method has access to all information, whether or not private. Therefore, as shown in block 155, the matching method can identify which of the queried variables are public or private for each donor. For convenience of discussion, the number of private variables will be assumed to have a value of Y. For each donor, as shown in block 157, Y must be greater than or equal to the value of MIN_PRIVATE for that donor to be considered further. Put another way, if Y is less than MIN_PRIVATE for a particular donor, then the donor is excluded from further consideration in this query. Since Y and MIN_PRIVATE vary between donors, a charity may get very different results using slight variations in a query.

To assure a minimum level of certainty, in block 162 NO_MATCH is compared to the number of private variables that do not match. In this regard, NO_MATCH sets the maximum number of private variables that cannot match. For example, if NO_MATCH is set to the value 2, then no more than 2 private variables can not match. If 3 private variables do not match, then the query exceeds the level of certainty requested by the charity, and the particular donor profile is removed from further consideration in this query.

It may be possible, however, that the charity sets NO_MATCH to a very low number, for example, 1. Thereby, no more than 1 private variable is allowed not to match. Such a level of certainty, although desirable for the charity, may not provide the necessary level of anonymity for the donor. Therefore in block 164 the value of NO_MATCH must be greater than or equal to the value of LIMIT. For example, assume the donor sets the value of LIMIT at 2, then the matching method removes the donor's profile from further consideration when NO_MATCH is set to only 0 or 1. It will be appreciated that other methods may be used to adjust the uncertainty in the matching process.

Provided that the charity and donor have agreed on a proper level of certainty and anonymity in blocks 157, 162, and 164, then the method 140 proceeds to block 166. In block 166 the variables in the charity's query are compared to corresponding variables in the donors' profile templates. If the comparison identifies a sufficient degree of similarity between the query and donors' profiles, then the charity is notified of the matches. Of course, block 169 indicates that the charity only receives information that has not been identified as private by each of the donors. Although method 140 may set a specific degree of similarity required to satisfy the query, block 168 may be used to provide a goodness of fit factor for adjusting the requisite similarity. Accordingly, the degree of similarity could be adjusted from needing an exact match to expanding identified matches to include those where several factors do not match. It will be appreciated that different goodness of the factors may be used in varying applications.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A process operating on a computer system, the process for matching a donor and a charity, comprising:
receiving current donor information that includes a plurality of current donor parameters;
identifying at least one of the current donor parameters as a private parameter;
receiving current charity information that includes a plurality of current charity parameters;
comparing current donor parameters, including the private parameter, to corresponding current charity parameters;
determining if the current donor and the current charity are a match; and
transmitting current charity parameters, excluding any private parameters, to the current donor.

2. The process according to claim 1, further including the step of maintaining a current database of current charities and current donors.

3. The process according to claim 1, further including the step of maintaining a historical database of past successful matches between past charities and past donors.

4. The process according to claim 3, further including the steps of:
interpreting one of the current donor parameters to indicate a desired outcome;
extracting from the historical database a set of similar past donors that have parameters similar to those of the current donor; and
defining a corresponding set of similar past charities, each charity in the set of similar past charities having reached the desired outcome with a corresponding past donor in the set of similar past donors.

5. The process according to claim 4, wherein a goodness-of-fit factor is used in selecting the set of similar past donors, the goodness-of-fit factor indicative of a minimum number of parameters that must match.

6. The process according to claim 4 further including the step of reviewing the set of similar past charities to identify a current charity, and arranging for the selected current charity to receive the transmitted current donor parameters.

7. The process according to claim 4 further including the step of selecting matching current charities from a database of current charities, the matching current charities having parameters similar to those in the set of similar past charities, and selected to receive the transmitted current donor parameters.

8. The process according to claim 7, wherein a goodness-of-fit factor is used in selecting the current charity, the goodness-of-fit factor indicative of the minimum number of parameters that must match.

9. The process according to claim 8, wherein a goodness-of-fit factor is used in selecting the set of similar past donors, the goodness-of-fit factor indicative of a minimum number of parameters that must match.

10. The process according to claim 3, further including the steps of:
interpreting one of the current donor parameters to indicate a desired outcome;
extracting from the historical database a set of similar past donors that have parameters similar to those of the current donor;
defining a corresponding set of similar past charities, each charity in the set of similar past charities having reached the desired outcome with a corresponding past donor in the set of similar past donors;
selecting matching current charities from a database of current charities, the matching current charities having parameters similar to those in the set of similar past charities;
extracting from the historical database a set of similar past charities that have parameters similar to those of the current charity;
defining a corresponding set of similar past donors, each donor in the set of similar past donors having reached the desired outcome with a corresponding past charity in the set of similar past charities;
selecting matching current donors from a database of current donors, the matching current donors having parameters similar to those in the set of similar past donors;
finding the current donor in the selected matching current donors; and
finding the current charity in the selected current matching charities.

11. The process according to claim 1, wherein the determining step further includes using a goodness-of-fit factor indicative of the minimum number of parameters that must match.

12. The process according to claim 1 wherein the identifying step includes identifying donor parameters using two privacy levels, public or private.

13. The process according to claim 1 wherein the identifying step includes identifying donor parameters using more than two levels of privacy.

14. The process according to claim 1, further including the step of receiving from the donor a value setting the minimum number of private parameters that must be used in the determining step.

15. The process according to claim 1, further including receiving from the charity a value setting the maximum number of private variables that are allowed not to match in the determining step.

16. The process according to claim 15, further including receiving from the donor a value setting an acceptable limit on the value the charity sets as the maximum number of private variables that are allowed not to match in the determining step.

17. The process according to claim 1, further including the step of providing the computer systems as a server portion and a client portion.

18. The process according to claim 17, wherein the client portion is provided as a mobile wireless device.

19. A method for automatically and confidentially matching a donor with a charity, the method operating on a processor, comprising:
receiving gifting information from the donor, the gifting information including private donor data and sharable donor data;
receiving need information from the charity, the need information including private charity data and sharable charity data;
comparing the gifting information to the need information, including private and sharable data; and
identifying a match responsive to the comparison.

20. The method according to claim 19, further including transmitting, after the match has been identified, only sharable donor data to the charity.

21. The method according to claim 19, further including transmitting, after the match has been identified, only sharable charity data to the donor.
